(19) United States
(12) Patent Application Publication
(10) Pub. No.: US 2013/0092432 A1
(43) Pub. Date: Apr. 18, 2013

(54) IN-SITU MOISTURE SENSOR AND/OR SENSING CABLE FOR THE MONITORING AND MANAGEMENT OF GRAIN AND OTHER DRY FLOWABLE MATERIALS

(71) Applicants: Robert David Crompton, Calgary (CA); Ronald Glen Larson, Calgary (CA)

(72) Inventors: Robert David Crompton, Calgary (CA); Ronald Glen Larson, Calgary (CA)

(73) Assignee: OPISYSTEMS INC., Calgary, AB (CA)

(21) Appl. No.: 13/806,030

(22) PCT Filed: Jun. 22, 2011
(86) PCT No.: PCT/CA2011/000731

§ 371 Date: Dec. 20, 2012

Related U.S. Application Data
(60) Provisional application No. 61/357,228, filed on Jun. 22, 2010.

(51) Int. Cl. H02G 3/02

(52) U.S. Cl. CPC H02G 3/02
USPC 174/70 R

(57) ABSTRACT

The present invention relates to an apparatus and method that permits a user to detect and report conditions within a column (or “quantity” which allows for vertical or non-vertical application of sensor cables) of dry, flowable, bulk materials within a storage facility.

### FIELD

The present invention relates to an apparatus and method that permits a user to detect and report conditions within a column (or “quantity” which allows for vertical or non-vertical application of sensor cables) of dry, flowable, bulk materials within a storage facility.

### BACKGROUND

Dry, flowable, bulk materials can be stored in various types of storage facilities. Bulk storage may present a dynamic environment with changes in temperature, humidity, and possibly the development of undesirable conditions such as moisture, pests, mold, rot, gases and the like, as well as by the introduction of treatments, such as heated, cooled, dehumidified or dehydrated, or moist air, gases for oxygen replacement, chemicals, pesticides, fungicides, anti-biotic agents, smoke, fireproofing, or energy or product-enhancing substances.

Current industry practice to address the dynamic storage environment has included the placement within the stored material of individual sensors integrated within the storage facility structure, and removal of physical samples during movement of the materials or via ports or portals in the facility. These systems are unsatisfactory, as the number and spacing of sensors is limited and cost-prohibitive, the sample rates are not sufficient for real-time or near-real-time analysis, or the sampling is difficult to perform.

### SUMMARY

Therefore, it may be desirable for an operator to employ an apparatus for sensing changes in numerous environmental parameters at numerous locations within the column of goods so that measures can be taken to optimize quality and reduce spoilage.

The invention provides for a sensor apparatus for a bulk storage facility comprising at least one cable with two ends comprising at least one tensile strand, at least two electrically conductive strands one of which may be the tensile strand, at least one sensor attached to the cable between the two cable ends and operatively connected to both electronically conductive strands, the cable's first end fixed at one side of the bulk storage facility so that the cable runs through the facility's storage cavity; the cable's second end may be fixed at or near to the cavity's opposite side; at one end of the cable a power supply may be attached to provide controlled electrical current to the conducting strands, and a data device is attached to at least one of the electrically conductive strands to controllably communicate over the cable with any sensor attached to the cable.

The invention provides for a sensor apparatus for bulk storage comprising a cable with two ends comprising at least one tensile strand, at least two electrical strands one of which may be the tensile strand, at least one data conductive strand one of which may be the tensile strand, with or without an insulating coating; a connector at a first end of the cable comprising sealing means to seal the strands of the cable from the environment and selectively insulate a strand from another strand; an attachment point to attach the first end of the cable within a cavity of a bulk storage facility, a connector at a second end of the cable comprising, an attachment point to attach the second end of the cable within the cavity, a connection of the two electrical strands to a switchable electrical power supply, a connection of the at least one data strand to a data collection and controller device, at least one sensor unit attached to the cable between its two ends at a predetermined location the sensor unit comprising: a body disposed when assembled and attached around the cable within the body, an electrical power storage means (capacitor, battery) operatively attached to the electrical strands to receive and then store electrical power, a sensor package comprising non-volatile digital memory with a readable unique identification indicia, read-write digital memory to receive, store, retrieve and send sensor output, a sensor with digital output signaling a quality or quantity sensed, a programmable controller with connections from the cable's strands and to the storage means and to the sensor package all sealed to the cable permitting the sensor to acquire samples from the sensor's environment in the bulk storage, the data collection and controller device connected with the cable's strands for selectively supplying electrical power to the electrical strands and for communication with the programmable controller to control sensor operation and collect sensor output data tagged with the unique identification indicia of the sensor package.

The invention provides for a method of obtaining data from known fixed points within the cavity of a storage facility from which a condition of materials stored within the cavity can be determined or inferred, comprising the steps of providing electrical power over a high tensile strength cable's conductor portion to an energy store contained within a sensor package attached at a midpoint on the cable's length for a period of time, ceasing power supply and causing the sensor package to sample its environment, store the qualitative or quantitative data generated as a result of the sensing event, and sending that data together with the sensor's identity through the cable.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### DESCRIPTION OF DRAWINGS

Referring to the drawings, several aspects of the present invention are illustrated by way of example, and not by way of limitation, in detail in the figures, wherein:

FIG. 1 is a schematic representation of one embodiment of the present invention.

FIG. 2 is a schematic representation of another embodiment of the present invention.

FIG. 3 is a side, sectional view of one embodiment of the sensor array and sensor.

FIG. 4 is a section view across a vertical mid-line of an exemplar grain silo showing one sensor array and associated monitor and control devices

FIG. 5 is a cross-section view of a cable of the apparatus

FIG. 6 is a combined cut-away view of the cable with a rough schematic of the circuitry and components of an exemplar of a sensor, mounted on the cable

### DETAILED DESCRIPTION

The detailed description set forth below in connection with the appended drawings is intended as a description of the present invention and is not intended to represent the only embodiments contemplated by the inventor. The detailed description includes specific details for the purposes of providing a comprehensive understanding of the present invention. However, it will be apparent to those skilled in the art that the present invention may be practiced without these specific details.

The phrase “dry, flowable, bulk goods” or “bulk materials” is employed herein to refer to goods or materials the moisture content of which is low enough that they would generally be considered to be dry solids, rather than a liquid or slurry, so that flowability of the goods is not determined by viscosity or other metrics relevant to the flow of liquids or slurries. Further, the phrase “column of goods” or “column of materials” is used to merely reference the collective body of the stored, dry, flowable, bulk goods or materials. The phrase “column of goods” contemplates all relevant storage methods and it is not intended to limit this disclosure to storage facilities that store goods in a substantially vertical fashion, such as silo.

Bulk materials could include, by way of example and not so as to limit the term: all flowable dry materials in storage such as all the grains and oilseeds and their flours, meals, products and by-products; spices, nuts, coffee, cocoa, seeds of all native and cultivated crops, fruit (whole, parts preprocessing and dried, flaked, etc.); wood and wood products, seashells and seafood products, fiber products, vegetables, grain, feed, plastic pellets, chemical powders, etc) where there are conditions which can be sensed to help design or control maintenance, safety, or processing (things like moisture, temperature, CO2 or Nitrogen or O2, Ozone, CO, aromatics, static pressure, noise/vibration, methane or other off-gases from expected processes, markers indicating presence of desired or undesirable chemical, biological or physical processes; strain forces—to measure the load or loading on a particular sensor or cable, biological products such as the presence and quantity of molds, fungi, bacteria, spores, mycotoxins, insects and their outputs, mites, protozoa, etc. that can affect quality or value of the stored product; electrical and static electrical properties such as frequency, wave shifts, reflections, noise (electrical), time domain reflectometry, time domain transmissivity, etc.; other types of chemical detection such as marker gases, hydrocarbons, pesticides, fungicides, insecticides, etc.; and light or electromagnetic reflectivity, absorption, shift, frequency or amplitude) which may be stored in bulk materials storage facilities.

Bulk materials storage facilities in this context could include, by way of example: large and small silos, tanks, hoppers, bins, rectangular buildings, piles, bagsand similar stores where the materials for which the facility is designed can be moved into and/or out of storage.

During the storage of the goods, it may be desirable to monitor storage environment parameters, such as, but not limited to: humidity and temperature within a column of goods. Further, monitoring of the fluids (gases, typically) within the interstial space between particles of material, such as carbon dioxide, nitrogen and other fluids, may provide information relevant to facilitate an increase or maintenance of quality, while decreasing spoilage, of the stored good.

Bulk materials storage facilities also routinely affect the stored materials, and can even provide certain treatments for the materials such as heating, cooling, dehydrating, humidifying or rehydrating, mixing, fireproofing, chemically treating, aging, smoking, or protecting. Inert fluids can be used to replace interstitial air between particles or pieces of the stored materials to prevent combustion or slow and/or terminate organic or other processes. Other chemicals may be introduced to control organic or other processes such as decomposition or rot, fungal growth, insect or pest infestation and damage or spoilage.

The present invention may provide an apparatus and method to allow monitoring of various dry, flowable, bulk goods while in storage. For example, the operator may utilize the information acquired through the present invention, as will be discussed below, for developing strategies which employ an air source 18, or other techniques known to those skilled in the art, to modulate the storage environment in an effort to optimize quality of the stored good.

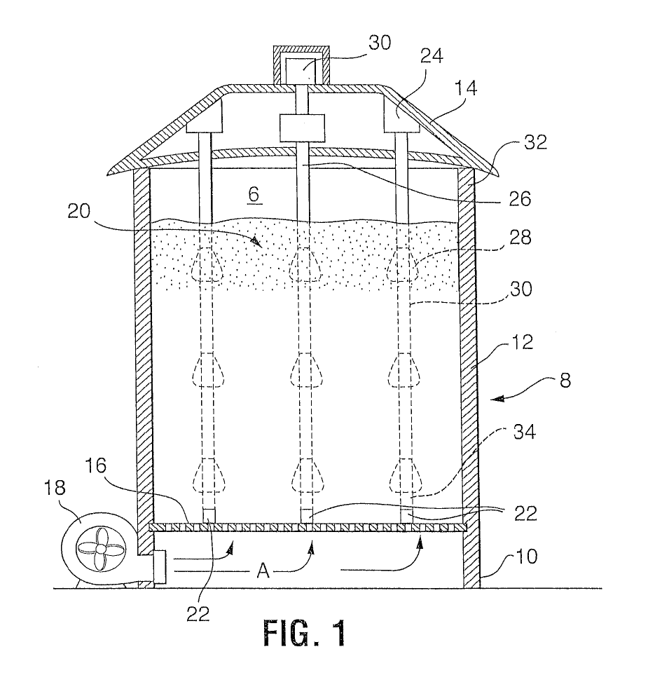

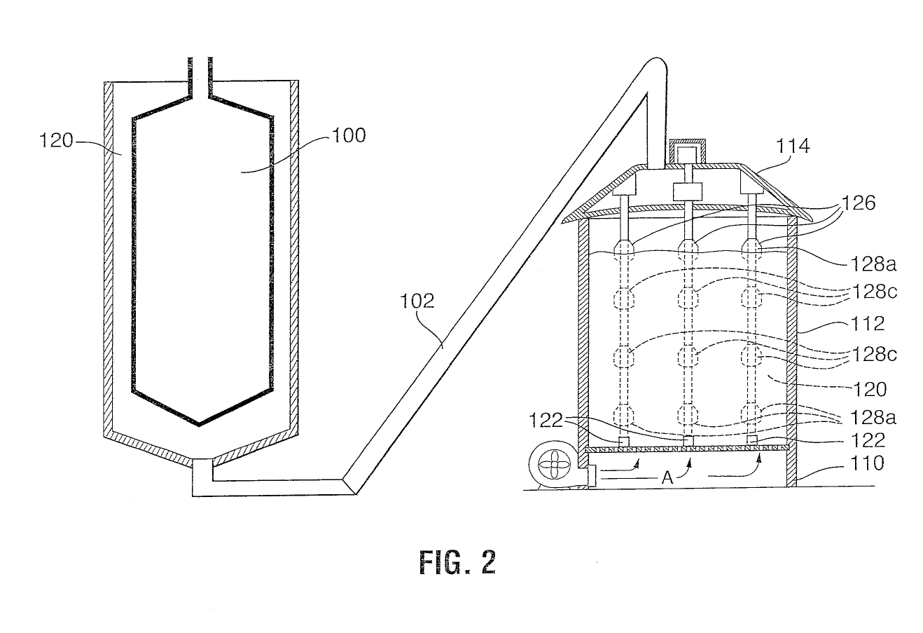

Referring to FIGS. 1 and 2 an apparatus for providing a sensor array 30 within a storage facility 8 is shown. The goods 20 may arrive at storage facility 8 directly, such as harvested products. Or goods 20 may arrive at storage facility 8 indirectly, for example, harvest products may be pre-processed 100 such as through a grain dryer or a wood pellet processing facility.

In one embodiment, a storage facility 8 may have three sections; first end 10, body 12 and second end 14, and contain a hollow chamber 6 for the storage of dry, flowable, bulk goods 20, for example grains, wood pellets and other biomass products. Proximal to first end 10, storage facility may have a floor 16 that spans across hollow chamber 6. Floor 16 may contain openings such as slits, perforations so that fluid (where the word “fluid” is used throughout; this includes “gas” or “gases”) may move through from source 18 to the first end 10 towards the second end 14. Fluid may be gases, such as humidity controlled or thermally controlled air, that comes from a source 18, which may be a turbine, or otherwise, fan and/or a heater.

The second end of the storage facility 14 may include a second end attachment means 24 for attaching one end of sensor array 32 to the second end of the storage facility. For example, second end attachment means 24 may be a hook or purpose-built hanger incorporated within a data and power connector. One end of sensor array 32 may be formed to integrate with the second end attachment means so that the sensor array 30 is fixed at second end of the storage facility 14. For example, sensor array 30 may hang from second end attachment means and extend the length of the storage facility towards floor 16.

As an option, floor 16 may have first end attachment means to which the other end of sensor array 34 may attach thereby allowing sensor array to be suspended between first end and second end of the storage facility. Further, sensor array 30 may be suspended at a desired tension to more accurately place and hold sensors within the bulk materials loaded into the storage facility.

Sensor array 30 may be one tension supporting line 40 with two unconnected-ends that further comprise an outer casing 42. Outer casing 42 may be made from an insulating material such as a plastic polymer like high density polyethylene, and outer casing 42 may be wrapped around the entire length and diameter of sensor array 30. Sensor array 30 may further comprise at least one line 40. At least one line 40 may, in addition to supporting a tension force, be used to conduct electricity and or computer readable signals. Line 40 may, therefore, be composed of materials that are able to support the desired tension and conduct electrical and computer readable signals.

As one can appreciate, such a material may be any number of appropriate metals, such as braided steel or high tensile strength and non-stretchable metallic or composite braided with or including or comprising an electrical and/or data conductor.

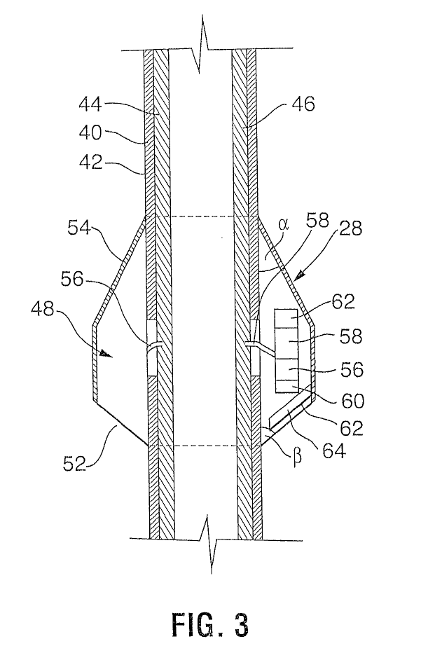

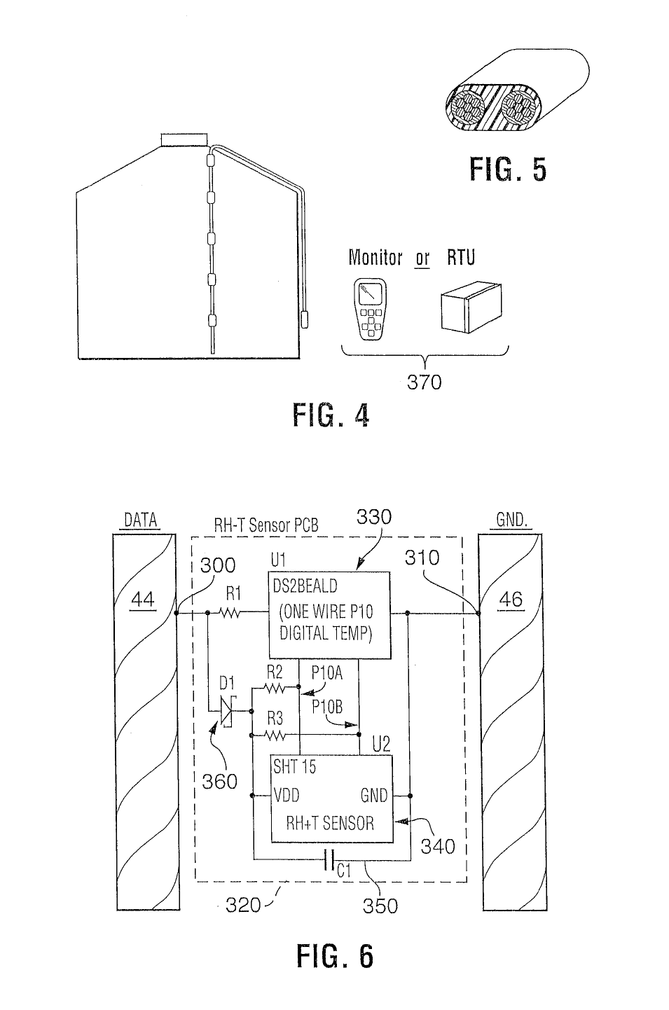

In one embodiment, as shown in FIG. 3, line 40 may comprise two separate lines, a ground line 44 and a communication line 46. Ground line 44 may provide a reference point for measuring electrical current on communication line 46 or ground line 44 may provide a common ground for electrical currents or ground line may provide a direct connection through the body of storage facility 12 to ground.

Communication line 46 may act as a power conduit to transfer electrical energy and communication line 46 may also act as conduit for signals from sensors 28 to central node 30. As will be discussed further below, and as will be appreciated, communication line 46 may pass through attachment means 24, depending upon orientation within a given storage facility, to connect with central node 30. In the case where only a single sensor array 30 exists, the capability of the central node may be contained within attachment means 24.

As shown in FIG. 3, sensor array 30 may house one or more sensors 28. Housing of sensor 28 within sensor array 30 may occur by a number of appropriate techniques. For example, in one embodiment, sensor 28 may centrally align around sections of sensor array 30 at locations where outer casing 42 has been removed so that sensor 28 may directly connect with ground line 44 through ground connection 56 and communication line 46 through communication connection 57. In other options, sensor 28 may be fixed to the sensor array 30 and ground line 56 and communication line 57 may pierce outer casing 42 to directly communicate with their respective lines of the sensor array. Whichever of these appropriate techniques, or others, for housing sensor 28 upon sensor array 30 ensures that the position of sensor 28 will remain relatively fixed while exposed to a turbulent environment, such as when dry, flowable, bulk goods are loaded into and unloaded out of storage facility 8.

Sensors 28 may be contained within a sensor body 48 which is robust enough to protect the sensor and associated componentry during the turbulence associated with dry, flowable, bulk goods being loaded into and unloaded out of storage facility 8. Sensor body 48 may have a first sensor body end 52 that faces substantially towards first end 10 and a second sensor body end 54 that faces substantially towards second end 14. Sensor body 48 may be shaped to decrease the drag of dry bulk goods that are flowing from second end 14 towards first end 10, possibly during loading of dry, flowable, bulk goods into storage facility 8. For example, second sensor body end 54 may be substantially tapered so that the angle between second sensor body end 52 and outer casing 42 (angle α as shown in FIG. 3) is substantially acute. Sensor body 48 may also be shaped so that first sensor end 52 more directly faces the first end 10, which may increase the surface area of the sensor body that is in the (generally predictable direction of) flow of interstial fluids within the column of goods 20. For example the angle between first sensory body end 52 and outer casing 42 (angle β as shown in FIG. 3) may be substantially less acute than angle α.

In one embodiment of the present invention there may be a sensor window 62 located on first sensor body end 52 to provide fluid communication between the inside and outside of the sensor body. Sensor window 62 may contain a selectable filter 64 so that interstial fluids within the column of goods 20 may pass through the window and elicit a detection event by the sensor 28. Filter 64 may be porous and the pore sizing and spacing may be selected to permit a specific interstial fluid or fluids to pass through sensor window 62. Said another way, the filter may be composed of a material that permits tailored permeability. For example, filter 64 may contain pores selected to permit carbon dioxide to pass through the filter and elicit a detection event and to prevent the passage of other constituents of the interstitial fluid from contacting the sensor. A precision porous plastic, metallic, membrane or composite filter has been found to permit such tailored permeability

As one skilled in the art of dry, flowable bulk material storage would appreciate, the constituents of the interstial fluid may depend upon which particular good is being stored within a given column of goods or on what treatment or maintenance is being performed. For example, in the storage of grains the interstial fluid may comprise water vapour, carbon dioxide, organo-phosphenes, ozone, nitrogen and other fluids that displace oxygen from the interstial fluid. Further, there may be chemical matters that are indicative of an undesirable process, such as but not limited to biologic processes of mold growth, rot, insect presence or other undesirable biologics. Further, in the storage of, for example, wood pellets, the interstial fluid may contain a variety of organo-volatiles and aromatics. Other sensors may be used, and an exemplary list of characteristics or events which are of interest or potential interest to a storage operator is set out above. Therefore, filter 64 and sensor 28 can be selected to permit fluidic communication with the sensor and detection of any number of specific constituents of the interstial fluids. Further, filter 64 and sensor 28 can be selected to detect changes in other detectable parameters, such as temperature and pressure, or as noted above, within the interstial fluid and/or the column of goods, as the case may be.

The operator may select, based upon the specific dry, flowable bulk material being stored, the nature of said storage and other relevant factors, the specific constituents of the interstial fluids and detectable parameters it is desirable to measure via sensors 28 placed upon sensor array 26. Further, depending upon the diameter of hollow chamber 6, the operator may employ more than one sensor array to provide a greater area of detection and may deploy more than one sensor type on any sensor array. Depending upon the height of hollow chamber 6, and the factors mentioned above, the operator may determine how many sensors are employed on a given sensor array.

In one embodiment, sensor array 30 may have multiple sensors, each sensor 28 may be selected to detect one specific constituent or detectable parameter. In another embodiment, there may be a plurality of sensors 28 upon a sensor array selected to detect one specific constituent or detectable parameter. In yet another embodiment, there may be a plurality of sensors 28 upon a sensor array selected to detect one specific constituent or detectable parameter and another plurality of sensors selected to detect another specific constituent or detectable parameter upon the same sensor array. For example, as shown in FIG. 2, sensors 128a may be employed on more than one sensor array 126 and be selected to detect changes in moisture content within the interstial fluid and sensors 128b may be selected to detect changes in temperature and sensors 128c may be selected to detect changes in carbon dioxide levels within the interstial fluid.

In yet another embodiment, sensor array 28 may have multiple sensors and each sensor may have the ability to detect more than one specific constituent or detectable parameter.

Associated with a sensor, within sensor body 48 there may be other elements such as a programmable controller 56, an energy storage means 58 and a memory means 60. Programmable controller 56 may be a microprocessor that receives output information from sensor 28. Energy storage means 58 may be, for example a battery or a capacitor that is powered by communication line 57 via communication connection 58 in a technique commonly termed “parasitic power providing electrical power over data lines.

Programmable controller 56 may receive information from sensor 28 and depending upon programming (for example, responsive to: polling, internal or external timer or otherwise) programmable controller 56 may send signals via communication connection 57 to communication line 46. Programming may be onboard the sensor or at an external site in communication with the sensor. Signals may comprise binary information that encodes, among other information, individual sensor identity information and output information from sensor 28. Signals may travel along communication line 46 to central node 30. Central node 30 may be a central gathering and or processing means so that all signals from sensors 58 are gathered and processed into data that is useful in the field of managing dry, flowable bulk goods. For example, sensor signals may be gathered and processed by the central node to provide humidity and temperature information on a column of grain to optimize a drying operation. Further, sensor signals may provide for the detection of contaminants (biological or otherwise) or other chemical indicators of undesirable events within the column. The data may be transmitted, through wired or wireless means, from the central node to permit the operator access to said useful data, for example from a personal computer or computer network.

With reference to FIG. 6, a sensor package has a connection 300, 310 to each of two cable strands 44, 46. The sensor package contains a circuit (RH-T Sensor PCB) 320 with components: resistors R1, R2 and R3; 1-wire® (Maxim Integrated Products) communications bus controller device with digital temperature sensor U1 (DS28EA00) 330 operatively connected via leads PI0A and PI0B to U2 digital relative humidity and temperature sensor component SHT15 340; capacitor C1 350; and rectifying diode (or similar) D1 360. D1 and C1 obtain (and provide) parasitic power to operate sensor 340 (operatively connected with VDD and GND to 340) while data line voltage over P10A and P10B drops. The controller (for example Monitor or RTU) 370 sends 1-wire® commands to U1 330 in turn to control P10A and P10B to operate sensor 340 and communicate sensor data while maintaining adequate voltage at devices 330 and 340, during and between operations. The result is sensed data being communicated over strands 44, 46 of the cable of the sensor array 30. The data includes the sensor output as well as a unique identifier indicia for the particular sensor package. It is to be understood that more than one sensor package may be deployed on and operate over a single cable using 1-wire® or similar one-conductor bus techniques without requiring multiple individual leads for each sensor; data from multiple sensors and commands to multiple sensors can be individually handled using well-known multiplexing and demultiplexing technologies and typical 1-wire® or one conductor communications techniques and systems which are known to one skilled in the art of multiple-device communications.

Sensor data may be used to infer conditions of the stored material. For instance, RH of interstitial gases and environmental temperature at a point in the stored material permits an inference of the moisture content of the solid material without requiring direct measurement of the solid's moisture content. The inferences are made using models or tables derived from experimental data obtained from samples of like material (eg. grain, corn, wood pellets of certain similar characteristics) to the material in storage of interest in an application.

It will be understood by those skilled in the art that the provision of on-demand, multi-sensor, real-time or near-real-time information about conditions within a storage facility permit improvements to processes and can increase (among other things) energy efficiencies. For example, by deploying a silo with air circulation means equipped with the apparatus of this invention immediately after a grain-drying machine for removing moisture from harvested crops before storage, it is possible to accept heated grain with higher than usual moisture content in the equipped silo, and manage the final drying processes by introduction of dry air into the silo while measuring interstitial humidity in the silo'd grain; this truncates the drying cycle in the drier, dramatically reducing energy expenditures by as much or more than 25% net. This is possible by using real-time sensor data during circulation of dry air through the silo instead of drying the grain in a dedicated high-energy-consuming drier, typically fired with hydrocarbons or electricity; the process may be somewhat slower overall, but in-silo drying can be done during a time when the grain would have been silo-stored in any event. Larger throughputs of harvested to finished grain into storage can also be realized if part of the finishing is done in-silo. Conversely, higher humidity air can be introduced so as to modify, and in some case, increase commodity moisture content, so as to optimize commodity value,

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are know or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. Sensor apparatus for a bulk storage facility comprising:
(a) at least one cable with two ends comprising:
(i) at least one tensile strand
(ii) at least two electrically conductive strands, one of which may be the tensile strand
(b) at least one sensor attached to the cable between the two cable ends, and operatively connected to both electronically conductive strands
(c) the cable's first end fixed at one side of the bulk storage facility so that the cable runs through the facility's storage cavity; the cable's second end may be fixed at or near to the cavity's opposite side;
(d) at one end of the cable a power supply is attached to provide electrical power at controlled voltages to the conducting strands, and a data device is attached to at least one of the electrically conductive strands to controllably communicate over the cable with any sensor attached to the cable;

2. A sensor apparatus for bulk storage comprising:
(a) a cable with two ends, comprising
(i) at least one tensile strand
(ii) at least two electrical strands, one of which may be the tensile strand
(iii) at least one data conductive strand, one of which may be the tensile strand
(iv) an insulating coating
(b) a connector at a first end of the cable, comprising
(i) sealing means to seal the strands of the cable from the environment and selectively insulate a strand from another strand
(ii) an attachment point to attach the first end of the cable within a cavity of a bulk storage facility
(c) a connector at a second end of the cable, comprising
(i) an attachment point to attach the second end of the cable within the cavity
(ii) a connection of the two electrical strands to a switchable electrical power supply
(iii) a connection of the at least one data strand to a data collection and controller device
(d) at least one sensor unit attached to the cable between its two ends at a predetermined location
(i) the sensor unit comprising
(A) a body disposed when assembled and attached around the cable
(B) within the body:
(1) an electrical power storage means (capacitor, battery) operatively attached to the electrical strands to receive and then store electrical power
(2) a sensor package, comprising:
a) non-volatile digital memory with a readable unique identification indicia
b) read-write digital memory to receive, store, retrieve and send sensor output
c) a sensor with digital output signaling a quality or quantity sensed
d) a programmable controller
(3) connections from the cable's strands to the storage means and to the sensor package, sealed to the cable permitting the sensor to acquire samples from the sensor's environment in the bulk storage
(ii) the data collection and controller device connected with the cable's strands for selectively supplying electrical power to the electrical strands, and for communication with the programmable controller to control sensor operation and collect sensor output data tagged with the unique identification indicia of the sensor package

3. A method of obtaining data from fixed points within the cavity of a storage facility from which a condition of materials stored within the cavity can be determined or inferred, comprising the steps of:
(a) providing electrical power over a high tensile strength cable's conductor portion to an energy store contained within a sensor package attached at a midpoint on the cable's length for a period of time
(b) ceasing power supply and causing the sensor package to sample its environment, store the qualitative or quantitative data generated as a result of the sensing event, and sending that data together with the sensor's identity through the cable
